(19) United States
(12) Patent Application Publication
(10) Pub. No.: US 2002/0198942 A1
(43) Pub. Date: Dec. 26, 2002

(54) Method and system for reducing unsolicited communications via multiple channels of communication

(76) Inventor: Barbara Rae Ryan, Chicago, IL (US)

Correspondence Address: Jennifer A. Albert, Esq., Hunton & Williams, Suite 1200, 1900 K Street, N.W., Washington, DC, 20006, US

(21) Appl. No.: 09/884,022

(22) Filed: Jun. 20, 2001

(51) Int. Cl. G06F 15/16

(52) U.S. Cl. 709/206

(57) ABSTRACT

A method and system for reducing wanted communications from providers (e.g., service and/or product providers, advertisers, etc.) via multiple channels of communication, such as email, mail and telemarketing calls, through a single consumer contact are disclosed. A consumer may pay a one-time, periodic or other type of fee in order to provide the consumer's contact information, which may include name, address, telephone number and email address. The present invention may parse the consumer's information where relevant information may be forwarded to the appropriate database or databases. Marketers may be informed of the consumer's request via the one or more databases where marketing contact lists may be purged of consumer contact information. As a result, unsolicited communications via multiple channels of communication may be reduced. The present invention further provides a service that may be sold in conjunction with other products and services of a provider/client entity. Privacy features of the present invention may be easily combined with other products and services. In addition, privacy features of the present invention may be offered to consumers when they complain about marketing tactics and/or other privacy concerns.

### BACKGROUND OF THE INVENTION

The present invention relates generally to the field of reducing unsolicited communications, in particular, to a method and system for reducing unsolicited communications via multiple channels of communication through a single contact.

Consumers are bombarded daily with unwanted solicitations in various formats, including email, mail and telemarketing calls.

Consumers are forced to spend time in routinely sifting through stacks of mail to discard unwanted junk mail. Other inconveniences may include additional recycling efforts and more trash. In addition, advertisers (e.g., service providers, product providers, etc.) may expend large amounts of resources to uninterested consumers with little or no success. Mass mailings generally result in wasted resources for the provider and negative consume relations.

With the advent of the Internet and other forms of electronic communication, consumers frequently receive mass emails for products and services. Mass emails are a cost efficient way of reaching a large group of consumers. However, the service providers and consumers generally bear the cost and burden of mass emails. For example, Internet Service Providers are forced to expend resources in transmitting mass emails and deal with annoyed consumers. In another example, consumers are forced to spend time and effort in identifying junk email and cleaning inboxes, resulting in wasted time and higher Internet charges.

Telemarketers include live representatives as well as voice recordings, which may be used to contact consumers at home, in the office or other location.

Oftentimes, telemarketing calls disrupt family dinners, television shows and other activities. For example, telemarketers often interrupt phone calls, local and long-distance calls, thereby inconveniencing the consumer and costing the consumer valuable time and money. Unanswered telemarketing calls may also flood a consumer's answering machine. Telemarketers may be wasting valuable resources on uninterested and often highly agitated consumers.

One method of avoiding telemarketing calls is through the use of a caller id box to identify a telemarketing call. This may alert the consumer of the incoming call; however, the calls are not prevented from disrupting the consumer. In addition, caller id boxes may require an activation fee, monthly charges and other fees.

Consumers may request removal from a solicitor's contact list. However, this generally involves answering the telemarketing call and proactively informing the solicitor of the consumer's request. By informing one solicitor, other unrelated solicitors are not prevented from contacting the consumer. Therefore, the consumer may be required to request removal off numerous calling lists as solicitors call the consumer. This method of dealing with solicitors is burdensome and time consuming.

While the level of annoyance and burden is high, consumers are oftentimes not informed or aware of services that reduce unsolicited communications from providers, advertisers and other entities. Even if consumers are aware of such services, they oftentimes do not know how to register for effective reduction of unwanted solicitations.

Currently, reduction of unwanted solicitations is available for a single channel. As a result, consumers who want to reduce communications from more than one channel are required to register separately for each channel.

These and other drawbacks exist with current methods and systems.

### BRIEF SUMMARY OF THE NVENTION

Advantages of the invention will be set forth in part in the description which follows, and in part will be understood from the description, or may be learned by practice of the invention. The advantages of the invention may be realized and attained by means of the instrumentalities and combinations particularly pointed out in the appended claims.

This invention, in one aspect, includes a method for reducing unsolicited communications via multiple channels through a single consumer contact comprising the steps of establishing a contact with a consumer; offering a privacy service wherein the privacy service comprises reducing unsolicited communications for a combination of communication channels to the consumer; enrolling the consumer to receive the privacy service via a single consumer contact; processing consumer information for a consumer selected combination of communication channels; parsing consumer information; and forwarding parsed consumer information to one or more preference services to enable one or more marketers to purge one or more contact lists.

Another embodiment of the present invention includes a method for reducing unwanted communications via multiple communication channels, the method comprising the steps of enabling a provider to establish a contact with a consumer to offer one or more of product, service, advertisement and information to the consumer; offering a privacy service to the consumer through the provider wherein the privacy service comprises reducing unsolicited communications for a combination of communication channels to the consumer; enrolling the consumer to receive the privacy service via a single consumer contact with the provider; and forwarding consumer information to a processor for processing consumer information for a consumer selected combination of communication channels and to enable one or more marketers to purge one or more contact lists.

Another embodiment of the present invention includes a method for reducing unwanted communications via multiple communication channels, the method comprising the steps of establishing a contact with a provider; requesting a privacy service wherein the privacy service comprises reducing unsolicited communications; identifying a combination of communication channels from which to reduce unsolicited communications via a single consumer contact; and providing consumer information at the single consumer contact.

In another aspect, the invention includes a system for reducing unsolicited communications via multiple channels through a single consumer contact. The system comprises contact means for establishing a contact with a consumer; offering means for offering a privacy service wherein the privacy service comprises reducing unsolicited communications for a combination of communication channels to the consumer; enrollment means for enrolling the consumer to receive the privacy service via a single consumer contact; processing means for processing consumer information for a consumer selected combination of communication channels; parsing means for parsing consumer information; and forwarding means for forwarding parsed consumer information to one or more preference services to enable one or more marketers to purge one or more contact lists.

Another embodiment of the present invention includes a system for reducing unwanted communications via multiple communication channels, the system comprising contact means for enabling a provider to establish a contact with a consumer to offer one or more of product, service, advertisement and information to the consumer; offering means for offering a privacy service to the consumer through the provider wherein the privacy service comprises reducing unsolicited communications for a combination of communication channels to the consumer; enrollment means for enrolling the consumer to receive the privacy service via a single consumer contact with the provider; and forwarding means for forwarding consumer information to a processor for processing consumer information for a consumer selected combination of communication channels and to enable one or more marketers to purge one or more contact lists.

Another embodiment of the present invention includes a system for reducing unwanted communications via multiple communication channels, the system comprising contact means for establishing a contact with a provider; requesting means for requesting a privacy service wherein the privacy service comprises reducing unsolicited communications; identifying means for identifying a combination of communication channels from which to reduce unsolicited communications via a single consumer contact; and input means for providing consumer information at the single consumer contact.

The accompanying drawings, which are incorporated in and constitute a part of this specification, illustrate various embodiments of the invention and, together with the description, serve to explain the principles of the invention.

### BRIEF DESCRIPTION OF THE DRAWINGS

FIG. 1 is a diagram illustrating an example of a system for reducing unsolicited communications via multiple channels, according to an embodiment of the present invention.

FIG. 2 is a diagram illustrating another example of a system for reducing unsolicited communications via multiple channels, according to an embodiment of the present invention.

FIG. 3 is a flowchart illustrating a method for reducing unsolicited communications via multiple channels, according to an embodiment of the present invention.

FIG. 4 is an example of a registration page, according to an embodiment of the present invention.

### DETAILED DESCRIPTION OF THE INVENTION

The present invention provides a method and system for reducing wanted communications from providers (e.g., service and/or product providers, advertisers, etc.) via multiple channels of communication, such as email, mail and telemarketing calls, through a single consumer contact.

During a consumer contact, privacy features may be offered to a consumer. Consumer contact may include inbound communications as well as outbound communications, for example. A consumer may select a combination of communication channels from which unsolicited correspondences are to be reduced. A consumer may provide contact information, which may include one or more names or other identifier, one or more addresses, one or more telephone numbers and one or more email addresses. The present invention may parse the consumer's information where relevant information may be forwarded to one or more appropriate databases. Marketers may be informed of the consumer's request via the one or more databases. As a result, unsolicited communications via multiple channels may be reduced by a single contact.

This service may be sold to consumers directly on a periodic, one-time fee or other fee arrangement. In addition, this service may be sold to clients (e.g., providers, companies, etc.) who may pay a per-enrollee fee (or based on other fee arrangements) to appease callers who complain about unsolicited communications from the client and/or other sources. For example, a consumer who complains about a telemarketing call may be offered a service for reducing a substantial amount of telemarketing, mail and email combination from other companies and/or sources.

In another example, the service of the present invention may be offered as a free benefit associated with another product and/or service. The service of the present invention may also be offered as a free service to consumers who may ask not to be solicited. Other variations may be implemented.

By offering the service of the present invention to consumers directly or indirectly, consumers are made aware of such services and given opportunities to minimize disruptions and unwanted communications from multiple channels. As a result, consumers are better informed and receive valuable privacy services.

Benefits to providing (e.g., clients, advertisers, etc.) may include savings of marketing resources. Unresponsive consumers are generally resentful and uninterested. Further, marketing costs are expensive. By purging call lists of consumers who request removal of their contact information, resources are saved and consumer relations and reputation are enhanced.

Privacy is an important factor in an individual's life. Thus, reducing unwanted solicitations from multiple channels is a concern applicable to generally all consumers. As a result, privacy features of the present invention may be easily combined with other products and services. In addition, privacy features of the present invention may be offered to consumers when they complain about marketing tactics and/or other privacy concerns. Thus, the present invention may further provide effective ways of informing consumers of privacy features including the reduction of unwanted solicitations.

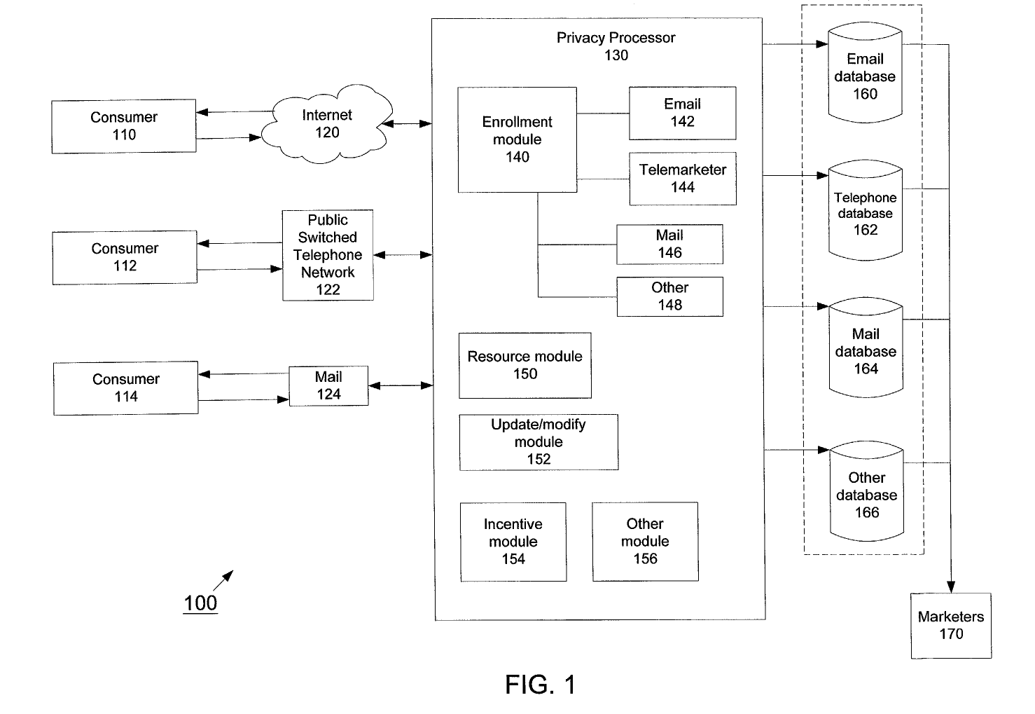

FIG. 1 is a diagram illustrating an example of a system 100 for reducing unsolicited communications via multiple channels, according to an embodiment of the present invention.

Consumer 110 may communicate with privacy processor 130 via Internet 120 or other electronic form of communication. Consumer 110 may be identified by one or more email addresses. Consumer 112 may communicate with privacy processor 130 via Public Switch Telephone Network 122 or other form of voice communication (e.g., POTS, etc.). Consumer 112 may be identified by one or more telephone numbers. Consumer 114 may communicate with privacy processor 130 via mail 124. Other forms of communication may be supported by the present invention. Consumer 114 may be identified by one or more mailing addresses.

Privacy processor 130 may interact with consumers directly or via an affiliated entity. For example, privacy processor 130 may receive a request from a consumer initiated communication. In another example, privacy processor 130 may offer privacy services to consumers directly. In another embodiment of the present invention, privacy services offered by privacy processor 130 may be offered in conjunction with other product or service offerings.

Privacy processor 130 may include various modules and features, which may include enrollment module 140, resource module 150, update/modify module 152, incentive module 154 and other module 156. Through enrollment module 140, a consumer may select a combination of communication channels from which to reduce unwanted solicitations. These channels may include email 142, telemarketing calls 144, mail 146 and other forms of communication 148.

Resource module 150 may provide tips and other helpful resource information to consumers regarding the reduction unwanted solicitations and other information.

Update/Modify module 152 may enable a consumer to add or delete communication channels as well as update contact information. According to an embodiment of the present invention, a user may register with the system of the present invention to reduce unwanted solicitations and communications via one or more channels. At a later point in time, the consumer may update or modify the consumer's registration information to include other channels of communication. Also, a channel of communication may be deleted or otherwise modified. In addition, consumer contact information may be updated as well. For example, consumers may move, change jobs, install additional phone lines and other changes. Other variations may be implemented.

Incentive module 154 enables a consumer to receive added protection against unwanted solicitations. Incentives may be customized to a consumer based on type of communication channel and other factors. For example, return-to-sender stickers with “remove from mailing list” or other similar message may be forwarded to consumers for additional protection. In another example, a mini digital tape player may be forwarded with a “remove me” or other similar message for telemarketers. Consumer incentives provide enhanced protection against solicitors who may slip past the privacy processor of the present invention.

According to an embodiment of the present invention, a consumer may participate in a single initial contact where the consumer provides consumer information to the privacy processor 130. Privacy processor 130 may then parse the consumer information and forward the appropriate information to the correct channels and/or databases. Databases of customer information may include email address database 160, telephone number database 162, mail address database 164 and other database 166 containing other forms of customer information.

Databases 160, 162, 164 and 166 may be accessible to marketers 170. Marketers 170 may include service providers, product providers, advertisers and/or other entities. Marketers 170 may retrieve a list of consumers requesting marketers to cease correspondences with the consumers. Databases 160, 162, 164 and 166 may be combined or maintained separately. One or more databases may be part of one or more preference services that maintain a list of consumers requesting removal from email, mail and/or telephone lists. Direct marketers may access the databases to purge names and contact information associated with consumers requesting removal. Most reputable companies use preference services to purge names. As a result, communications may be reduced significantly.

For example, a consumer may desire to reduce the amount of mail, email and telemarketing calls. The consumer may enroll with one or more of email 142, telemarketing 144, mail 146 and other 148. The consumer may provide consumer information, which may include a combination of consumer name, address data, phone data and email data. As many consumers maintain multiple phone lines, email and other accounts, multiple forms of contact information may be provided. Other consumer information may include other individuals within the consumer's household, part of a street name and other information. By providing this information to privacy processor 130 at a single contact, the privacy processor may then parse the consumer data and forward the appropriate information to the appropriate one or more databases. In this example, the consumer's one or more email addresses may be forwarded to email database 160. The consumer's one or more telephone numbers may be forwarded to telephone database 162. The consumer's full address or part of an address may be forwarded to mail database 164. Other information may be parsed and forwarded as well.

According to another embodiment, the privacy processor may extract consumer information from a registered consumer database. In this example, the consumer may not be required to enter information when requesting for the reduction of unwanted communications, according to the present invention. For example, a pre-registered consumer may simply request for a reduction of one or more communication channels from a provider. The provider may then access a database of consumer information and extract email addresses, telephone numbers and mailing addresses, as requested and authorized by the consumer.

Privacy provider 130 may offer various privacy features to consumers at periodic, one-time fee or other fee arrangements.

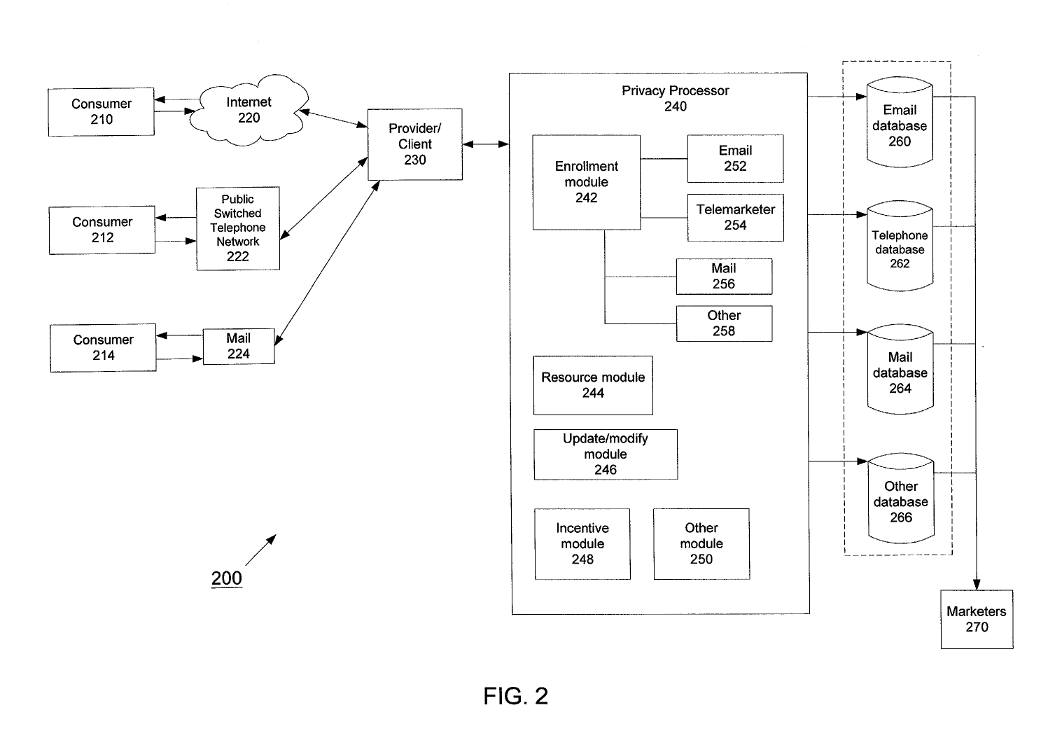

FIG. 2 is a diagram illustrating another example of a system 200 for reducing unsolicited communications via multiple channels, according to an embodiment of the present invention. FIG. 2 includes a Provider/Client entity illustrated by 230. Provider/Client 230 may include one or more banks, credit card companies, product providers, service providers, advertisers and other entities. Provider/Client entities may market more efficiently and effectively by eliminating consumers who would not purchase Provider/Client services and/or products due to the channel being used, lack of interest or other reasons. Resources, such as time, money and stamps, for example, may be conserved.

Consumer 210 may communicate with Provider/Client 230 via Internet 220 or other electronic form of communication. Consumer 212 may communicate with Provider/Client 230 via Public Switch Telephone Network 222 or other form of voice communication (e.g., POTS, etc.). Consumer 214 may communicate with Provider/Client 230 via mail 224. Other forms of communication may be supported by the present invention.

Provider/Client 230 may offer privacy services to consumers supported by privacy processor 240. In an embodiment of the present invention, privacy processor 240 may be separate from Provider/Client 230. In another embodiment of the present invention, privacy processor 240 may be combined or affiliated with Provider/Client 230. Other arrangements and relationships may be supported between Provider/Client 230 and privacy processor 240.

According to another embodiment of the present invention, privacy processor 240 may provide privacy services to Provider/Client 230 to enable Provider/Client 230 to provide privacy services to existing or potential consumers 210, 212, 214, via various communication channels. In this example, Provider/Client 230 may pay a per-enrollee fee to privacy processor 240 for the ability to provide privacy features to consumers. Other fee arrangements may be supported.

Privacy processor 240 may include various modules and features, which may include enrollment module 242, resource module 244, update/modify module 246, incentive module 248 and other module 250. Through enrollment module 242, a consumer may select a combination of communication channels form which to reduce unwanted solicitation. These channels may include email 252, telemarketing calls 254, mail 256 and other forms of communication 258.

Resource module 244 may provide information regarding the reduction unwanted solicitations and other information, such as tips and other helpful resources. Update/Modify module 246 may enable a consumer to add or delete communication channels as well as update contact information. Incentive module 248 enables a consumer to receive added protection against unwanted solicitations. Incentives may be customized to a consumer based on type of communication channel and other factors.

According to an embodiment of the present invention, a consumer may participate in a single initial contact where the consumer provides consumer information to Provider/Client 230. Provider/Client 230 may forward consumer information to privacy processor 240. Privacy processor 240 may then parse the consumer information and forward the appropriate information to the correct channels and/or databases. Databases of customer information may include email address database 260, telephone number database 262, mail address database 264 and other database 266 containing other forms of customer information.

Databases 260, 262, 264 and 266 may be accessible to marketers 270. Marketers 270 may include providers/clients, service providers, product providers, advertisers and/or other entities. Marketers 270 may then retrieve a list of consumers requesting marketers to cease correspondences with the consumers. Databases 260, 262, 264 and 266 may be combined or maintained separately.

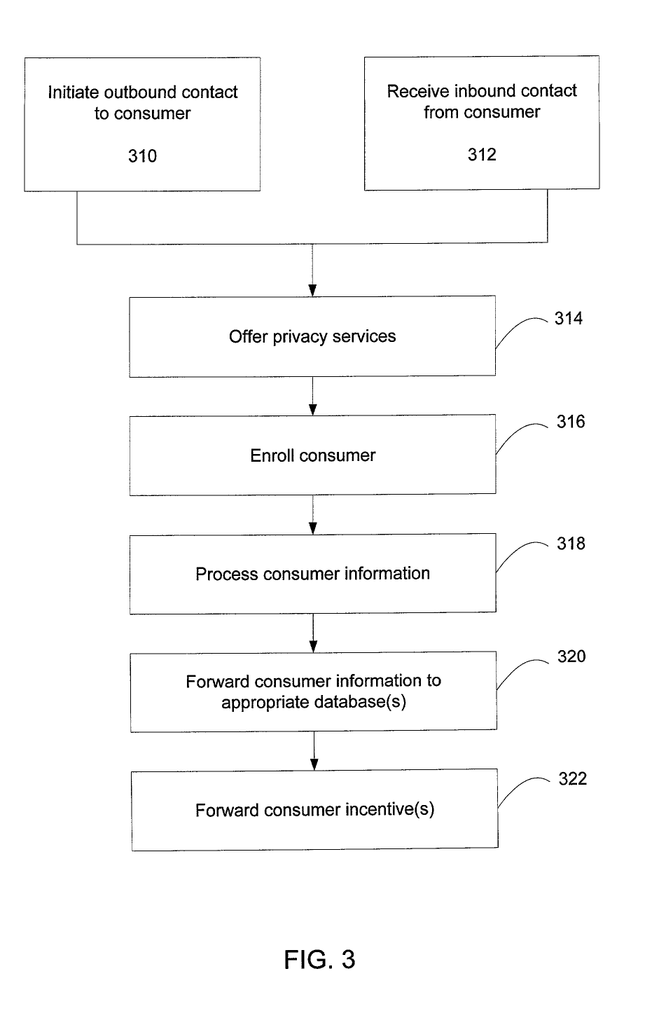

FIG. 3 is a flowchart illustrating a method for reducing unsolicited communications via multiple channels, according to an embodiment of the present invention.

At step 310, an outbound contact to a consumer may be initiated. At step 312, an inbound contact may be received from a consumer. At step 314, privacy features may be offered to a consumer. At step 316, a consumer may enroll with a system to receive selected privacy services. At step 318, consumer information may be processed. At step 320, relevant consumer information may be forwarded to one or more appropriate databases. At step 322, consumer incentives may be forwarded to registered consumers. The steps of FIG. 3 will be described in further detail below.

At step 310, an outbound contact to a consumer may be initiated by a Provider/Client, privacy processor or other authorized entity. According to an embodiment of the present invention, a consumer may be contacted in connection with a product or service offering, advertisement or other form of contact. Privacy features may be offered to a consumer as an additional service with broad scope and applicability to all or most consumers. Privacy features may be offered in response to a complaint about a telemarketing call or other form of solicitation. As illustrated in step 310, privacy features may be offered in an outbound contact to a consumer.

At step 312, an inbound contact may be received from a consumer as a request to cease communication or as a complaint. In another example, a consumer may initiate a contact to purchase products and/or services where the consumer may be offered privacy features as an additional service.

At step 314, privacy features may be offered to a consumer. Privacy features may include reduction of unwanted solicitations and advertisements via multiple channels of communication. Communication channels may include email, telephone, mail and other forms of communication. According to another embodiment of the present invention, consumers may indicate preference information. For example, a consumer may request the reduction of communications from a specific merchant, group or class of merchants via one or more channels of communications. Other consumer preferences may include reduction of a particular type of communication for one or more identified products and/or services as well as type or class of products and/or services. Other specifics may be identified to further meet consumer's needs and requests. Consumers may also specify restrictions. For example, a consumer may request time restrictions applied to telemarketers. Other consumer preferences and restrictions may be specified.

At step 316, a consumer may enroll in privacy features of the present invention. A privacy processor may obtain consumer information, such as name, address, one or more phone numbers, one or more email addresses, other household members and other contact information. The consumer may select multiple channels to eliminate or reduce unwanted solicitations, advertisements and other communications. This feature of the present invention enables a consumer to register once to reduce unwanted communications via multiple channels of communication.

At step 318, consumer information may be processed by the present invention. When multiple channels of communication are selected for reduction of unwanted solicitations and advertisements, the system of the present invention may parse consumer information. According to an embodiment of the present invention, consumer information may be entered manually through a consumer input screen. According to another embodiment of the present invention, consumer information may be automatically extracted from a profile database, registration database or other source of consumer information, as requested or authorized by the consumer.

At step 320, relevant contact information may be forwarded to the appropriate database or databases. For example, a consumer's email address, phone number and mailing address may be parsed and forwarded to the appropriate databases for handling the appropriate type of contact.

At step 322, consumer incentives may be provided to consumers for improved reduction of unwanted solicitations and other communications. For example, return-to-sender stickers with “remove from mailing list” or other similar message may be forwarded to consumers for added protection. In another example, a mini digital tape player may be forwarded with a “remove me” or other similar message for telemarketers. Consumer incentives provide enhanced protection for solicitors who may slip past the privacy processor of the present invention.

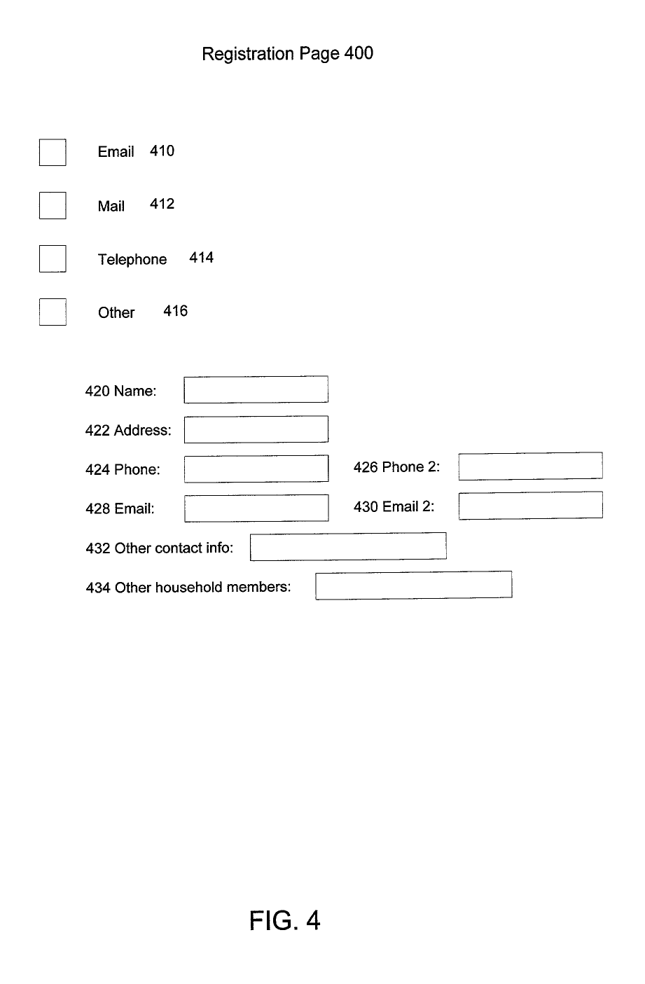

FIG. 4 is an example of a registration page 400, according to an embodiment of the present invention. A consumer may request privacy features of the present invention through a single contact where the consumer may request reduction of unwanted solicitations and communications via multiple channels of communication. For example, a consumer may select a combination of email 410, mail 412, telephone 414 and other forms of communication 416.

Consumer information may be entered. For example, a consumer may provide name data at 420; address data at 422; phone data at 424, 426; email data at 428, 430; other contact information at 432, and other household member data at 434. As discussed above, a consumer may maintain multiple forms of contact information, such as phone numbers, email accounts, etc. The privacy processor of the present invention may extract a portion of consumer information. For example, as street names may be spelled with some variations, the privacy processor may extract a portion of a street name to ensure a reduction of unwanted solicitations for a consumer. The information may be forwarded to a mail address database. By obtaining other household member data, solicitors may be prevented from sending communications to a household address with several different household members.

As is clear from the Detailed Description, the system and method of the present invention provides an easy, user-friendly, efficient means for reducing unsolicited communications via multiple channels through a single contact.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

What is claimed is:

1. A method for reducing unwanted communications via multiple communication channels, the method comprising the steps of:
establishing a contact with a consumer;
offering a privacy service wherein the privacy service comprises reducing unsolicited communications for a combination of communication channels to the consumer;
enrolling the consumer to receive the privacy service via a single consumer contact;
processing consumer information for a consumer selected combination of communication channels;
parsing consumer information; and
forwarding parsed consumer information to one or more preference services to enable one or more marketers to purge one or more contact lists.

2. The method of claim 1 wherein the contact comprises an inbound contact.

3. The method of claim 1 wherein the contact comprises an outbound contact.

4. The method of claim 1 wherein the step of offering privacy features further comprises a step of offering one or more of products and services.

5. The method of claim 1 wherein communication channels comprise email, telephone and mail.

6. The method of claim 1 further comprising a step of providing one or more consumer incentives.

7. A method for reducing unwanted communications via multiple communication channels, the method comprising the steps of:
enabling a provider to establish a contact with a consumer to offer one or more of product, service, advertisement and information to the consumer;
offering a privacy service to the consumer through the provider wherein the privacy service comprises reducing unsolicited communications for a combination of communication channels to the consumer;
enrolling the consumer to receive the privacy service via a single consumer contact with the provider; and
forwarding consumer information to a processor for processing consumer information for a consumer selected combination of communication channels and to enable one or more marketers to purge one or more contact lists.

8. The method of claim 7 wherein the communication channels comprise email, telephone and mail.

9. A method for reducing unwanted communications via multiple communication channels, the method comprising the steps of:
establishing a contact with a provider;
requesting a privacy service wherein the privacy service comprises reducing unsolicited communications;
identifying a combination of communication channels from which to reduce unsolicited communications via a single consumer contact; and
providing consumer information at the single consumer contact.

10. The method of claim 9 wherein communication channels comprise email, telephone and mail.

11. The method of claim 9 wherein consumer information comprises a combination of email address data, telephone number data and mailing address data.

12. The method of claim 9 further comprising a step of receiving one or more consumer incentives.

13. The method of claim 9 further comprising a step of identifying one or more consumer preferences regarding at least one of communication channel, type of communication and source of communication.

14. A system for reducing unwanted communications via multiple communication channels, the system comprising:
contact means for establishing a contact with a consumer;
offering means for offering a privacy service wherein the privacy service comprises reducing unsolicited communications for a combination of communication channels to the consumer;
enrollment means for enrolling the consumer to receive the privacy service via a single consumer contact;
processing means for processing consumer information for a consumer selected combination of communication channels;
parsing means for parsing consumer information; and
forwarding means for forwarding parsed consumer information to one or more preference services to enable one or more marketers to purge one or more contact lists.

15. The system of claim 14 wherein the contact comprises an inbound contact.

16. The system of claim 14 wherein the contact comprises an outbound contact.

17. The system of claim 14 further comprising second offering means for offering one or more of products and services.

18. The system of claim 14 wherein communication channels comprise email, telephone and mail.

19. The system of claim 14 further comprising incentive means for providing one or more consumer incentives.

20. A system for reducing unwanted communications via multiple communication channels, the system comprising:
contact means for enabling a provider to establish a contact with a consumer to offer one or more of product, service, advertisement and information to the consumer;
offering means for offering a privacy service to the consumer through the provider wherein the privacy service comprises reducing unsolicited communications for a combination of communication channels to the consumer;
enrollment means for enrolling the consumer to receive the privacy service via a single consumer contact with the provider; and
forwarding means for forwarding consumer information to a processor for processing consumer information for a consumer selected combination of communication channels and to enable one or more marketers to purge one or more contact lists.

21. The system of claim 20 wherein the communication channels comprise email, telephone and mail.

22. A system for reducing unwanted communications via multiple communication channels, the system comprising:
contact means for establishing a contact with a provider;
requesting means for requesting a privacy service wherein the privacy service comprises reducing unsolicited communications;
identifying means for identifying a combination of communication channels from which to reduce unsolicited communications via a single consumer contact; and
input means for providing consumer information at the single consumer contact.

23. The system of claim 22 wherein communication channels comprise email, telephone and mail.

24. The system of claim 22 wherein consumer information comprises a combination of email address data, telephone number data and mailing address data.

25. The system of claim 22 further comprising incentive means for receiving one or more consumer incentives.

26. The system of claim 22 further comprising preference means for identifying one or more consumer preferences regarding at least one of communication channel, type of communication and source of communication.
